(19) United States
(12) Patent Application Publication
(10) Pub. No.: US 2018/0187391 A1
(43) Pub. Date: Jul. 5, 2018

(54) LANDFILLING METHOD FOR REFURBISHING LANDSCAPES

(71) Applicant: BASF SE, Ludwigshafen (DE)

(72) Inventors: Josep Maria BRINGUE CAMPI, Sant Cugat (ES); Victor Caceres DIEZ, Barcelona (ES)

(21) Appl. No.: 15/125,504

(22) PCT Filed: Feb. 26, 2015
(86) PCT No.: PCT/EP2015/054026

§ 371 Date: Sep. 12, 2016

(30) Foreign Application Priority Data
Mar. 12, 2014 (EP) 14159084.4

(51) Int. Cl. E02D 31/00; B32B 27/40; B32B 27/08; B32B 27/06; B32B 5/20; C08G 71/04; B05D 1/02

(52) U.S. Cl. CPC E02D 31/004; C08G 2101/0016; B32B 27/08; B32B 27/065; B32B 5/20; C08G 71/04; B05D 1/02; B32B 2255/10; B32B 2266/0278; B32B 2274/00; B32B 2305/022; B32B 2305/38; B32B 2305/72; B32B 2318/00; E02D 2300/0048; B32B 27/40

(57) ABSTRACT

The present invention is directed to the use of a composite comprising a layer (L1) selected from the group of polyurethane layers, polyisocyanurat layers and polyurea layers as a landfill liner as well as a process for preparing a composite landfill liner comprising a layer (L1) selected from the group of polyurethane layers, polyisocyanurat layers and polyurea layers, the process comprising the step of applying a reaction mixture which is suitable to form a product selected from the group of polyurethane, polyisocyanurat and polyurea products onto a surface. Furthermore, the present invention is directed to a composite comprising a layer (L1) selected from the group of polyurethane layers, polyisocyanurat layers and polyurea layers, a primer layer on one surface of layer (L1), and a protective layer (L2) selected from the group of mortar layers or elastomer layers on the surface of the primer layer. In particular, the present invention is directed to the use of a composite comprising a polyurethane foam layer (L1) as a landfill liner, wherein the layer (L1) comprises a spray product as well as a preparing a composite landfill liner comprising a polyurethane foam layer (L1), the process comprising the step of applying a reaction mixture which is suitable to form a polyurethane foam onto a surface. Finally, the present invention is directed to a composite comprising a polyurethane foam layer (L1), a primer layer on one surface of layer (L1), and a protective layer (L2) selected from the group of mortar layers or elastomer layers on the surface of the primer layer.

The present invention is directed to the use of a composite comprising a layer (L1) selected from the group of polyurethane layers, polyisocyanurat layers and polyurea layers as a landfill liner as well as a process for preparing a composite landfill liner comprising a layer (L1) selected from the group of polyurethane layers, polyisocyanurat layers and polyurea layers, the process comprising the step of applying a reaction mixture which is suitable to form a product selected from the group of polyurethane, polyisocyanurat and polyurea products onto a surface. Furthermore, the present invention is directed to a composite comprising a layer (L1) selected from the group of polyurethane layers, polyisocyanurat layers and polyurea layers, a primer layer on one surface of layer (L1), and a protective layer (L2) selected from the group of mortar layers or elastomer layers on the surface of the primer layer. In particular, the present invention is directed to the use of a composite comprising a polyurethane foam layer (L1) as a landfill liner, wherein the layer (L1) comprises a spray product as well as a preparing a composite landfill liner comprising a polyurethane foam layer (L1), the process comprising the step of applying a reaction mixture which is suitable to form a polyurethane foam onto a surface. Finally, the present invention is directed to a composite comprising a polyurethane foam layer (L1), a primer layer on one surface of layer (L1), and a protective layer (L2) selected from the group of mortar layers or elastomer layers on the surface of the primer layer.

Dumping and mining sites all over the world often cause huge impact in the landscape, since although this impact is controlled and regulated by national or international standards which describe the refurbishing procedure after the mining or dumping activity is over, in most of the cases the processes leave waste and are harmful for the landscape.

One example are potash extraction sites which generate huge amounts of salt waste that, generally, is left outside. These salty mountains are dangerous for the environment as rainfall dissolves them, polluting rivers and water sources close by. There are some techniques to deal with this situation. Backfilling of the mining galleries was practiced but is very expensive.

A frequently used approach is to cover the respective area using geomembranes. Complex layer systems are disclosed in the state of the art, which combine the geomembranes with reinforcement layers, layers for filtration and separation, layers for drainage and protective layers.

However, previous to the application of the geomembrane, it is necessary to smoothen the surface first. So there are some steps that have to be followed before the actual layers installation can be started which also complicates the process.

DE 43 08 341 A1 discloses a process for preparing a protective layer on a covering layer which is used to cover a waste site.

GB 2 495 234 A discloses a composite material for use as a liner which comprises a drainage layer, support sheets and a cushioning layer. As one cushioning layer, permeable geotextile materials such as needle punch polypropylene are mentioned. According to GB 2 495 234 A, the composite materials disclosed therein have the advantage that the amount of gravel required when lining a whole full landfill is reduced.

DE 44 10 648 A1 discloses layering materials covering a waste site wherein the surface of the layering material has a structure like for example a honeycomb structure.

The composite materials used according to the state of the art have the disadvantage that complex structures have to be prepared which are then used to cover the respective site. Starting from the state of the art, it was one object of the present invention to provide processes for covering mining sites or waste sites using cheaper materials which provide similar properties with respect to the landfill or waste site. Furthermore, it was an object of the present invention to provide landfill liners which can be applied without adjustment of the slopes.

According to the present invention, this object is solved by the use of a composite comprising a layer (L1) selected from the group of polyurethane layers, polyisocyanurat layers and polyurea layers as a landfill liner.

It has surprisingly been found that the use of polyurethane layers, polyisocyanurat layers and polyurea layers results in improved properties such as better sealing properties and lower costs of the composite compared to those disclosed in the state of the art.

According to the present invention, it is possible to use the polyurethane, the polyisocyanurat or the polyurea in any suitable form for example as a compact layer or as a foam. The process according to the present invention has the advantage that the materials used, in particular the polyurethane used can be applied using standard methods and therefore results in lower costs.

Standard methods can be used to apply the polyurethane layers, polyisocyanurat layers and polyurea layers. It has been found advantageous to prepare the composite which is used as a landfill liner in situ. Therefore, it is not necessary to prepare a composite in advance which leaves the option of damage when delivered to the landfill site. In order to fill huge areas of a landfill site, it is necessary to use the main material in the layer (L1) in a form which is easy to apply to a given surface. Therefore, it is preferred to apply the layer (L1) by spraying the reaction mixture onto a surface.

According to a further embodiment, the present invention therefore is directed to the use of a composite as defined above, wherein the layer (L1) comprises a spray product.

In particular the use of spray products such as polyurethane products, polyisocyanurat products and polyurea products is advantageous because of its excellent adhesion properties (even to salty substrates), hydrophobicity and strength. Furthermore, the spraying processing technique, quick and without joints, makes it the most suitable way to refurbish in these situations without needs of flattening or changing the material disposal. The resulting layer preferably is a compact layer or a foam layer.

According to a further embodiment, the present invention is directed to the use of a composite as defined above, wherein the layer (L1) is selected from the group consisting of polyurethane compact layers, polyisocyanurat compact layers, polyurea compact layers, polyurethane foam layers, polyisocyanurat foam layers and polyurea foam layers.

According to a preferred embodiment, the present invention is directed to the use of a composite comprising a polyurethane foam layer (L1) as a landfill liner, wherein the layer (L1) comprises a spray product.

According to a further embodiment, the present invention is also directed to the use of a composite comprising a polyurethane foam layer (L1) as defined above, wherein the spray product is a rigid or semirigid polyurethane spray foam.

Suitable methods for applying the respective layers as well as suitable materials are generally known. Preferably, a reaction mixture which is suitable to form a polyurethane layer, polyisocyanurat layer or a polyurea layer is applied by suitable methods.

Polyurethanes, polyisocyanurates and polyureas have been known for a long time and are widely described in the literature. They are usually produced by reacting polyisocyanates with compounds having at least two hydrogen atoms which are reactive toward isocyanate groups in the presence of blowing agents, at least one catalyst and auxiliaries and/or additives.

Aliphatic and/or aromatic polyurea elastomer systems typically include an isocyanate, which may be an aliphatic or aromatic isocyanate. Suitable aliphatic isocyanates are known to those in the art. Thus, for instance, the aliphatic isocyanates may be of the type described in U.S. Pat. No. 4,748,192. Accordingly, they are typically aliphatic diisocyanates, and more particularly are the trimerized or the biuretic form of an aliphatic diisocyanate, such as, hexamethylene diisocyanate; or the bifunctional monomer of the tetraalkyl xylene diisocyanate, such as tetramethyl xylene diisocyanate. Cyclohexane diisocyanate is also to be considered a preferred aliphatic isocyanate.

Other useful aliphatic polyisocyanates are described in U.S. Pat. No. 4,705,814. They include aliphatic diisocyanates, for example, alkylene diisocyanates with 4 to 12 carbon atoms in the alkylene radical, such as 1,12-dodecane diisocyanate and 1,4-tetramethylene diisocyanate. Also described are cycloaliphatic diisocyanates, such as 1,3- and 1,4-cyclohexane diisocyanate as well as any desired mixture of these isomers; 1-isocyanato-3,3,5-trimethyl-5-isocyanatomethyl-cyclohexane (isophorone diisocyanate); 4,4′-, 2,2′- and 2,4′-dicyclohexylmethane diisocyanate, as well as the corresponding isomer mixtures, and the like. Aromatic isocyanates may also be employed.

Suitable organic polyisocyanates, defined as having 2 or more isocyanate functionalities, are conventional aliphatic, cycloaliphatic, araliphatic and preferably aromatic isocyanates. Specific examples include: alkylene diisocyanates with 4 to 12 carbons in the alkylene radical such as 1,12-dodecane diisocyanate, 2-ethyl-1,4-tetramethylene diisocyanate, 2-methyl-1,5-pentamethylene diisocyanate, 1,4-tetramethylene diisocyanate and preferably 1,6-hexamethylene diisocyanate; cycloaliphatic diisocyanates such as 1,3- and 1,4-cyclohexane diisocyanate as well as any mixtures of these isomers, 1-isocyanato-3,3,5-trimethyl-5-isocyanatomethylcyclohexane (isophorone diisocyanate), 2,4- and 2,6-hexahydrotoluene diisocyanate as well as the corresponding isomeric mixtures, 4,4′-2,2′-, and 2,4′-dicyclohexylmethane diisocyanate as well as the corresponding isomeric mixtures and preferably aromatic diisocyanates and polyisocyanates such as 2,4- and 2,6-toluene diisocyanate and the corresponding isomeric mixtures 4,4′-, 2,4′-, and 2,2′-diphenylmethane diisocyanate and the corresponding isomeric mixtures, mixtures of 4,4′-, 2,4′-, and 2,2-diphenylmethane diisocyanates and polyphenylenepolymethylene polyisocyanates (crude MDI), as well as mixtures of crude MDI and toluene diisocyanates. The organic di- and polyisocyanates can be used individually or in the form of mixtures. Particularly preferred for the production of rigid products is crude MDI containing about 50 to 70 weight percent polyphenyl-polymethylene polyisocyanate and from 30 to 50 weight percent diphenylmethane diisocyanate, based on the weight of all polyisocyanates used.

Also modified multivalent isocyanates, i.e., products obtained by the partial chemical reaction of organic diisocyanates and/or polyisocyanates are used. Examples include diisocyanates and/or polyisocyanates containing ester groups, urea groups, biuret groups, allophanate groups, carbodiimide groups, isocyanurate groups, and/or urethane groups.

Suitable aromatic polyisocyanates include, but are not necessarily limited to mphenylene diisocyanate; p-phenylene diisocyanate; polymethylene polyphenylene diisocyanate; 2,4-toluene diisocyanate; 2,6-toluene diisocyanate; dianisidine dine diisocyanate; bitolylene diisocyanate; naphthalene-1,4-diisocyanate; diphenylene 4,4′-diisocyanate and the like. Suitable aliphatic/aromatic diisocyanates, include, but are not necessarily limited to xylylene-1,3-diisocyanate; bis(4-isocyanatophenyl)methane; bis(3-methyl-4-isocyanatophenyl) methane; and 4,4′-diphenylpropane diisocyanate. The afforested isocyanates can be used alone or in combination. In one embodiment of the invention, aromatic isocyanates are preferred.

It is expected that the isocyanate will be at least partially reacted with an active hydrogen-containing material, in most cases, to form a quasi-prepolymer, although this is not an absolute requirement.

A quasi-prepolymer is highly preferred to maintain the 1:1 volume ratio processing with respect to development of the elastomer properties. If a quasi-prepolymer of relatively high viscosity is used, an alkylene carbonate may be used as a reactive diluent which lowers the viscosity of the quasi-prepolymer.

Specific examples include organic, preferably aromatic, polyisocyanates containing urethane groups and having a NCO content of 33.6 to 15 weight percent, preferably 31 to 21 weight percent, based on the total weight, e.g., with low molecular weight diols, triols, dialkylene glycols, trialkylene glycols, or polyoxyalkylene glycols with a molecular weight of up to 6000; modified 4,4′-diphenylmethane diisocyanate or 2,4- and 2,6-toluene diisocyanate, where examples of diand polyoxyalkylene glycols that may be used individually or as mixtures include diethylene glycol, dipropylene glycol, polyoxyethylene glycol, polyoxypropylene glycol, polyoxyethylene glycol, polyoxypropylene glycol, and polyoxypropylene polyoxyethylene glycols or -triols.

Prepolymers containing NCO groups with a NCO content of 29 to 3.5 weight percent, preferably 21 to 14 weight percent, based on the total weight and produced from the polyester polyols and/or preferably polyether polyols described below; 4,4′-diphenylmethane diisocyanate, mixtures of 2,4′- and 4,4′-diphenylmethane diisocyanate, 2,4,- and/or 2,6-toluene diisocyanates or polymeric MDI are also suitable. Furthermore, liquid polyisocyanates containing carbodiimide groups having a NCO content of 33.6 to 15 weight percent, preferably 31 to 21 weight percent, based on the total weight, have also proven suitable, e.g., based on 4,4′- and 2,4′- and/or 2,2′-diphenylmethane diisocyanate and/or 2,4′- and/or 2,6-toluene diisocyanate. The modified polyisocyanates may optionally be mixed together or mixed with unmodified organic polyisocyanates such as 2,4′- and 4,4′-diphenylmethane diisocyanate, polymeric MDI, 2,4′- and/or 2,6-toluene diisocyanate.

The active hydrogen-containing materials may include, but are not necessarily limited to polyols, high molecular weight polyoxyalkyleneamine, also described herein as amine-terminated polyethers, or a combination thereof.

The polyols include, but are not limited to, polyether polyols, polyester diols, triols, tetrols, etc., having an equivalent weight of at least about 500, and preferably at least about 1,000 up to about 3,000. Those polyether polyols based on trihydric initiators of about 4,000 molecular weight and above are especially preferred. The polyethers may be prepared from ethylene oxide, propylene oxide, butylene oxide or mixtures of propylene oxide, butylene oxide and/or ethylene oxide. Hydroxyl-terminated quasi-prepolymers of polyols and isocyanates are also useful in this invention. Especially preferred are amine-terminated polyether polyols, including primary and secondary amine-terminated polyether polyols of greater than 1,500 average molecular weight having from about 2 to about 6 functionality, preferably from about 2 to about 3, and an amine equivalent weight of from about 750 to about 4,000. Mixtures of amine-terminated polyethers may be used. In a preferred embodiment, the amine-terminated polyethers have an average molecular weight of at least about 2,500. These materials may be made by various methods known in the art.

The amine-terminated polyether resins useful in this invention, for example, are polyether resins made from an appropriate initiator to which lower alkylene oxides, such as ethylene oxide, propylene oxide, butylene oxide or mixtures thereof, are added with the resulting hydroxyl-terminated polyol then being aminated. When two or more oxides are used, they may be present as random mixtures or as blocks of one or the other polyether. In the amination step, it is highly desirable that the terminal hydroxyl groups in the polyol be essentially all secondary hydroxyl groups for ease of amination. Normally, the amination step does not completely replace all of the hydroxyl groups. However, the majority of hydroxyl groups are replaced by amine groups. Therefore, in a preferred embodiment, the amine-terminated polyether resins useful in this invention have greater than 50 percent of their active hydrogens in the form of amine hydrogens. If ethylene oxide is used, it is desirable to cap the hydroxyl-terminated polyol with a small amount of higher alkylene oxide to ensure that the terminal hydroxyl groups are essentially all secondary hydroxyl groups. The polyols so prepared are then reductively aminated by known techniques.

Also, high molecular weight amine-terminated polyethers or simply polyether amines may be used alone or in combination with the afforested polyols. The term “high molecular weight” is intended to include polyether amines having a molecular weight of at least about 2000. Particularly preferred are the JEFFAMINE Petrochemical Corporation; they include JEFFAMINE D-2000, JEFFAMINE D-4000, JEFFAMINE T-3000 and JEFFAMINE T-5000.

Alkylene carbonates are preferably chosen from the group of ethylene carbonate, propylene carbonate, butylene carbonate and dimethyl carbonate.

The use of the alkylene carbonate reduces the viscosity of the system, particularly the (A) component it resides sides in prior to mixing. The alkylene carbonate also allows slower effective reactivities in spray polyurea elastomer systems, improved properties and surface characteristics (flowability) and improved adhesion to the surfaces on which the elastomer is sprayed.

The polyurea elastomer systems may also include amine-terminated chain extenders in the formulation, which may preferably be placed within the (B) component. Suitable chain extenders include, but are not necessarily limited to, those aliphatic and cycloaliphatic diamine chain extenders mentioned in U.S. Pat. Nos. 5,162,388 and 5,480,955. Aromatic diamine chain extenders may also be useful, such as those described in U.S. Pat. No. 5,317,076.

Other conventional formulation ingredients that may be employed in polyurethane foams are foam stabilizers, also known as silicone oils or emulsifiers. The foam stabilizers may be an organic silane or siloxane. For example, compounds may be used having the formula:

RSiO—(RSiO)ₙ-(oxyalkylene)

where R is an alkyl group containing from 1 to 4 carbon atoms; n is an integer of from 4 to 8; m is an integer of from 20 to 40; and the oxyalkylene groups are derived from propylene oxide and ethylene oxide. See, for example, U.S. Pat. No. 3,194,773. Pigments, for example titanium dioxide, may be incorporated in the elastomer system to impart color properties to the elastomer. Typically, such pigments are added with the amine resin, for example, in the (B) component.

Reinforcing materials are known to those skilled in the art. For example, chopped or milled glass fibers, chopped or milled carbon fibers and/or mineral fibers are useful. Post curing of the polyurea elastomer is optional. Post curing will improve some elastomeric properties. Employment of post curing depends on the desired properties of the end product.

The (A) component and the (B) component of a polyurea elastomer system are combined or mixed, preferably under high pressure and most preferably directly in a high pressure spray equipment itself. In particular, a first and second pressurized stream of components, such as components (A) and (B), respectively, are delivered from separate chambers of the proportioner and are impacted or impinged upon each other at high velocity to effectuate an intimate mixing of the components and, thus, the formulation of the elastomer system, which is then coated onto the desired substrate via the spray gun. Component (A) and component (B) are usually employed in a 1:1 volumetric ratio although other ratios are possible.

As set out previously, the polyurethanes according to the present invention are usually produced by reacting polyisocyanates with compounds having at least two hydrogen atoms which are reactive toward isocyanate groups in the presence of blowing agents, at least one catalyst and auxiliaries and/or additives. Suitable compounds having at least two hydrogen atoms which are reactive toward isocyanate groups are known to the person skilled in the art and might be selected from compounds with OH groups, SH groups or NH groups. Preferably, polyols are used as compounds having at least two hydrogen atoms which are reactive toward isocyanate groups. A polyol composition comprising one or more polyols might be used.

Other ingredients that may be included in the polyol composition are further polyols, catalysts, surfactants, blowing agents, fillers, stabilizers, and other additives. The term “polyol(s)” includes polyols having hydroxyl, thiol, and/or amine functionalities.

The term “polyol(s)” particularly refers to compounds containing at least some polyester or polyoxyalkylene groups, and having a number average molecular weight of 200 or more. Where the word “polyol(s)” is used in conjunction with and to modify the words polyether, polyester, or polyoxyalkylene polyether, the word “polyol” is then meant to define a polyhydroxyl functional polyether.

Preferably, the polyols are polyoxyalkylene polyether polyols. These polyols may generally be prepared by polymerizing alkylene oxides with polyhydric amines. Any suitable alkylene oxide may be used such as ethylene oxide, propylene oxide, butylene oxide, amylene oxide, and mixtures of these oxides. The polyoxyalkylene polyether polyols may be prepared from other starting materials such as tetrahydrofuran and alkylene oxide-tetrahydrofuran mixtures; epihalohydrins such as epichlorohydrin; as well as aralkylene oxides such as styrene oxide.

Included among the polyether polyols are polyoxyethylene polyols, polyoxypropylene polyols, polyoxybutylene polyols, polytetramethylene polyols, and block copolymers, for example combinations of polyoxypropylene and polyoxyethylene poly-1,2-oxybutylene and polyoxyethylene polyols, poly1,4-tetramethylene and polyoxyethylene polyols, and copolymer polyols prepared from blends or sequential addition of two or more alkylene oxides. The polyoxyalkylene polyether polyols may be prepared by any known process such as, for example, the process disclosed by Wurtz in 1859 and Encyclopedia of Chemical Technology, Vol. 7, pp. 257-262, published by Interscience Publishers, Inc. (1951) or in U.S. Pat. No. 1,922,459.

The alkylene oxides may be added to the initiator, individually, sequentially one after the other to form blocks, or in mixture to form a heteric polyether. The polyoxyalkylene polyether polyols may have either primary or secondary hydroxyl groups. It is preferred that at least one of the amine initiated polyols are polyether polyols terminated with a secondary hydroxyl group through addition of, for example, propylene oxide as the terminal block.

For aliphatic amine initiated polyols, any aliphatic amine, whether branched or unbranched, substituted or unsubstituted, saturated or unsaturated, may be used. These would include, as examples, mono-, di, and trialkanolamines, such as monoethanolamine, methylamine, triisopropanolamine; and polyamines such as ethylene diamine, propylene diamine, diethylenetriamine; or 1,3-diaminopropane, 1,3-diaminobutane, and 1,4-diaminobutane. Preferable aliphatic amines include any of the diamines and triamines, most preferably, the diamines.

In one embodiment of the invention, polyols have number average molecular weights of 200-750 and nominal functionalities of 3 or more. By a nominal functionality is meant the functionality expected based upon the functionality of the initiator molecule, rather than the actual functionality of the final polyether after manufacture.

Preferably, the amine initiated polyols have hydroxyl numbers of 200 or more meq polyol/g KOH. At hydroxyl numbers of less than 200, the dimensional stability of the product begins to deteriorate.

There are other polyol types such as polythioether polyols, polyester amides and polyacetals containing hydroxyl groups, aliphatic polycarbonates containing hydroxyl groups, amine terminated polyoxyalkylene polyethers, polyester polyols, other polyoxyalkylene polyether polyols, and graft dispersion polyols. In addition, mixtures of at least two of the aforesaid polyols can be used. The preferable additional polyols are polyoxyalkylene polyether polyols and/or polyester polyols.

These further polyols include those initiated with polyhydroxyl compounds. Examples of such initiators are trimethylolpropane, glycerine, sucrose, sorbitol, propylene glycol, dipropylene glycol, pentaerythritol, and 2,2-bis(4-hydroxyphenyl)-propane and blends thereof. The preferred polyols are initiated with polyhydroxyl compounds having at least 4 sites reactive with alkylene oxides, and further may be oxyalkylated solely with propylene oxide.

A suitable polycarboxylic acid may be used such as oxalic acid, malonic acid, succinic acid, glutaric acid, adipic acid, pimelic acid, suberic acid, azelaic acid, sebacic acid, brassylic acid, thapsic acid, maleic acid, fumaric acid, glutaconic acid, a-hydromuconic acid, β3-hydromuconic acid, a-butyl-a-ethyl-glutaric acid, β3-diethylsuccinic acid, isophthalic acid, therphthalic acid, phthalic acid, hemimellitic acid, and 1,4-cyclohexanedicarboxylic acid.

A suitable polyhydric alcohol may be used such as ethylene glycol, propylene glycol, dipropylene glycol, trimethylene glycol, 1,2-butanediol, 1,5-pentanediol, 1,6-hexanediol, 1,7-heptanediol, hydroquinone, resorcinol glycerol, glycerine, 1,1,1-thrimethylo-propane, 1,1,1-trimethylolethane, pentaerythritol, 1,2,6-hexanetriol, a-methyl glucoside, sucrose, and sorbitol. Also included within the term “polyhydric alcohol” are compounds derived from phenol such as 2,2-bis(4-hydroxyphenyl)-propane, commonly known as Bisphenol A.

Suitable polyhydric polythioethers which may be condensed with alkylene oxides include the condensation product of thiodiglycol or the reaction product of a dicarboxylic acid such as is disclosed above for the preparation of the hydroxyl-containing polyesters with any other suitable thioether polyol. The hydroxyl-containing polyester may also be a polyester amide such as is obtained by including some amine or amino alcohol in the reactants for the preparation of the polyesters. Thus, polyester amides may be obtained by condensing an amino alcohol such as ethanolamine with the polycarboxylic acids set forth above or they may be made using the same components that make up the hydroxyl-containing polyester with only a portion of the components being a diamine such as ethylene diamine. Polyhydroxyl-containing phosphorus compounds which may be used include those compounds disclosed in U.S. Pat. No. 3,639,542.

Preferred polyhydroxyl-containing phosphorus compounds are prepared from alkylene oxides and acids of phosphorus having a P O equivalency of from about 72 percent to about 95 percent. Suitable polyacetals which may be condensed with alkylene oxides include the reaction produce of formaldehyde or other suitable aldehyde with a dihydric alcohol or an alkylene oxide such as those disclosed above.

Suitable aliphatic thiols which may be condensed with alkylene oxides include alkanethiols containing at least two —SH groups such as 1,2-ethanedithiol, 1,2-propanedithiol, 1,2-propanedithiol, and 1,6-hexanedithiol; alkene thiols such as 2-butane-1,4-dithiol; and alkene thiols such as 3-hexene1,6-dithiol.

Also suitable are polymer modified polyols, in particular, the so-called graft polyols. Graft polyols are well known to the art and are prepared by the in situ polymerization of one or more vinyl monomers, preferably acrylonitrile and styrene, in the presence of a polyether polyol, particularly polyols containing a minor amount of natural or induced unsaturation.

Methods of preparing such graft polyols may be found in columns 1-5 and in the Examples of U.S. Pat. No. 3,652,639; in columns 1-6 and the Examples of U.S. Pat. No. 3,823,201; particularly in columns 2-8 and the Examples of U.S. Pat. No. 4,690,956; and in U.S. Pat. No. 4,524,157.

Non-graft polymer modified polyols are also suitable, for example, as those prepared by the reaction of a polyisocyanate with an alkanolamine in the presence of a polyether polyol as taught by U.S. Pat. Nos. 4,293,470; 4,296,213; and 4,374,209; dispersions of polyisocyanurates containing pendant urea groups as taught by U.S. Pat. No. 4,386,167; and polyisocyanurate dispersions also containing biuret linkages as taught by U.S. Pat. No. 4,359,541. Other polymer modified polyols may be prepared by the in situ size reduction of polymers until the particle size is less than 20 mm, preferably less than 10 mm.

The average hydroxyl number of the polyols in the polyol composition should be 400 meq polyol/g KOH or more. Individual polyols may be used which fall below the lower limit, but the average should be within this range. Polyol compositions whose polyols are on average within this range make good dimensionally stable products. In calculating whether the average hydroxyl number is within this range, by definition only those polyols having a number average molecular weight of 200 or more are taken into account.

The blowing agents may be divided into the chemically active blowing agents which chemically react with the isocyanate or with other formulation ingredients to release a gas for foaming, and the physically active blowing agents which are gaseous at the exothermic foaming temperatures or less without the necessity for chemically reacting with the product ingredients to provide a blowing gas. Included with the meaning of physically active blowing agents are those gases which are thermally unstable and decompose at elevated temperatures. Examples of chemically active blowing agents are preferentially those which react with the isocyanate to liberate gas, such as CO₂. Suitable chemically active blowing agents include, but are not limited to, water, mono- and polycarboxylic acids having a molecular weight of from 46 to 300, salts of these acids, and tertiary alcohols.

Water is preferentially used as a blowing agent. Water reacts with the organic isocyanate to liberate CO₂ gas which is the actual blowing agent. However, since water consumes isocyanate groups, an equivalent molar excess of isocyanate must be used to make up for the consumed isocyanates. Water is typically found in minor quantities in the polyols as a byproduct and may be sufficient to provide the desired blowing from a chemically active substance. Preferably, however, water is additionally introduced into the polyol composition in amounts from 0.02 to 5 weight percent, preferably from 0.5 to 3 weight percent, based on the weight of the polyol composition.

The organic carboxylic acids used are advantageously aliphatic mono- and polycarboxylic acids, e.g. dicarboxylic acids. However, other organic mono- and polycarboxylic acids are also suitable. The organic carboxylic acids may, if desired, also contain substituents which are inert under the reaction conditions of the polyisocyanate polyaddition or are reactive with isocyanate, and/or may contain olefinically unsaturated groups.

Specific examples of chemically inert substituents are halogen atoms, such as fluorine and/or chlorine, and alkyl, e.g. methyl or ethyl. The substituted organic carboxylic acids expediently contain at least one further group which is reactive toward isocyanates, e.g. a mercapto group, a primary and/or secondary amino group, or preferably a primary and/or secondary hydroxyl group.

Suitable carboxylic acids are thus substituted or unsubstituted monocarboxylic acids, e.g. formic acid, acetic acid, propionic acid, 2-chloropropionic acid, 3-chloropropionic acid, 2,2-dichloropropionic acid, hexanoic acid, 2-ethyl-hexanoic acid, cyclohexanecarboxylic acid, dodecanoic acid, palmitic acid, stearic acid, oleic acid, 3-mercapto-propionic acid, glycolic acid, 3-hydroxypropionic acid, lactic acid, ricinoleic acid, 2-aminopropionic acid, benzoic acid, 4-methylbenzoic acid, salicylic acid and anthranilic acid, and unsubstituted or substituted polycarboxylic acids, preferably dicarboxylic acids, e.g. oxalic acid, malonic acid, succinic acid, fumaric acid, maleic acid, glutaric acid, adipic acid, sebacic acid, dodecanedoic acid, tartaric acid, phthalic acid, isophthalic acid and citric acid. Preferable acids are formic acid, propionic acid, acetic acid, and 2-ethylhexanoic acid, particularly formic acid.

The amine salts are usually formed using tertiary amines, e.g. triethylamine, dimethylbenzylamine, diethylbenzylamine, triethylenediamine, or hydrazine. Tertiary amine salts of formic acid may be employed as chemically active blowing agents which will react with the organic isocyanate. The salts may be added as such or formed in situ by reaction between any tertiary amine (catalyst or polyol) and formic acid contained in the polyol composition.

Combinations of any of the aforementioned chemically active blowing agents may be employed, such as formic acid, salts of formic acid, and/or water. Physically active blowing agents are those which boil at the exotherm foaming temperature or less, preferably at 50° C. or less. The most preferred physically active blowing agents are those which have an ozone depletion potential of 0.05 or less. Examples of physically active blowing agents are the volatile non-halogenated hydrocarbons having two to seven carbon atoms such as alkanes, alkenes, cycloalkanes having up to 6 carbon atoms, dialkyl ethers, cycloalkylene ethers and ketones; hydrochlorofluorocarbons (HCFCs); hydrofluorocarbons (HFCs); perfluorinated hydrocarbons (HFCs); fluorinated ethers (HFCs); hydrofluoroolefines (HFO) and decomposition products.

Examples of volatile non-halogenated hydrocarbons include linear or branched alkanes, e.g. butane, isobutane, 2,3 dimethylbutane, n- and isopentane and technical-grade pentane mixtures, n- and isohexanes, n- and isoheptanes, n- and isooctanes, n- and isononanes, n- and isodecanes, n- and isoundecanes, and n- and isododecanes. N-pentane, isopentane or n-hexane, or a mixture thereof are preferably employed as additional blowing agents. Furthermore, specific examples of alkenes are 1 pentene, 2-methylbutene, 3-methylbutene, and 1-hexene, of cycloalkanes in addition to cyclopentane are cyclobutane and cyclohexane, specific examples of linear or cyclic ethers are dimethyl ether, diethyl ether, methyl ethyl ether, vinyl methyl ether, vinyl ethyl ether, divinyl ether, tetrahydrofuran and furan, and specific examples of ketones are acetone, methyl ethyl ketone and cyclopentanone.

Preferred hydrochlorofluorocarbon blowing agents include 1-chloro-1,2-difluoroethane; 1-chloro-2,2-difluoroethane (142a); 1-chloro-1,1-difluoroethane (142b); 1,1-dichloro-1-fluoroethane (141b); 1-chloro-1,1,2-trifluoroethane; 1-chloro-1,2,2-trifluoroethane; 1,1-diochloro-1,2-difluoroethane; 1-chloro-1,1,2,2-tetrafluoroethane (124a); 1-chloro-1,2,2,2-tetrafluoroethane (124); 1,1-dichloro-1,2,2-trifluoroethane; 1,1-dichloro-2,2,2-trifluoroethane (123); and 1,2-dichloro-1,1,2-trifluoroethane (123); monochlorodifluoromethane (HCFC-22); 1-chloro-2,2,2-trifluoroethane (HCFC-133a); gemchlorofluoroethylene (R-1131a); chloroheptafluoropropane (HCFC-217); chlorodifluoroethylene (HCFC-1122); and trans-chlorofluoroethylene (HCFC-1131).

The most preferred hydrochlorofluorocarbon blowing agent is 1,1-dichloro-1-fluoroethane (HCFC-141b). Suitable hydrofluorocarbons, perfluorinated hydrocarbons, and fluorinated ethers include difluoromethane (HFC-32); 1,1,1,2-tetrafluoroethane (HFC-134a); 1,1,2,2-tetrafluoroethane (HFC-134); 1,1-difluoroethane (HFC-152a); 1,2-difluoroethane (HFC-142), trifluoromethane; heptafluoropropane; 1,1,1-trifluoroethane; 1,1,2-trifluoroethane; 1,1,1,2,2-pentafluoropropane; 1,1,1,3-tetrafluoropropane; 1,1,2,3,3-pentafluoropropane; 1,1,1,3,3-pentafluoro-n-butane; hexafluorocyclopropane (C-216); octafluorocyclobutane (C-318); perfluorotetrahydrofuran; perfluoroalkyl tetrahydrofurans; perfluorofuran; perfluoro-propane, -butane, -cyclobutane, -pentane, -cyclopentane, and -hexane, -cyclohexane, -heptane, and -octane; perfluorodiethyl ether; perfluorodipropyl ether; and perfluoroethyl propyl ether.

On the other hand the hydrofluoroolefines which are most suitable to be used are 1,1,1,4,4,4-hexafluorobutene, 1,3,3,3-Tetrafluoropropene, 1-chlor-3,3,3-trifluoropropene and 1,1,1,3,3-Pentafluoropropan.

Decomposition type physically active blowing agents which release a gas through thermal decomposition include pecan flour, amine/carbon dioxide complexes, and alkyl alkanoate compounds, especially methyl and ethyl formates.

Catalysts may be employed which greatly accelerate the reaction of the compounds containing hydrogen atoms which are reactive toward isocyanate groups, preferably hydroxyl groups and with the polyisocyanates. Examples of suitable compounds are cure catalysts which also function to shorten tack time, promote green strength, and prevent shrinkage. Suitable cure catalysts are organometallic catalysts, preferably organotin catalysts, although it is possible to employ metals such as lead, bismuth, titanium, copper, mercury, cobalt, nickel, iron, vanadium, antimony, and manganese.

Suitable organometallic catalysts, exemplified here by tin as the metal, are represented by the formula: R Sn[X—R—Y], wherein R is a C—C alkyl or aryl group, R is a C—C methylene group optionally substituted or branched with a C—C alkyl group, Y is hydrogen or an hydroxyl group, preferably hydrogen, X is methylene, an —S—, an —SR COO—, —SOOC— an —O S—, or an —OOC— group wherein R is a C—C alkyl, n is 0 or 2, provided that R is C only when X is a methylene group. Specific examples are tin (II) acetate, tin (II) octanoate, tin (II) ethylhexanoate and tin (II) laurate; and dialkyl (1-8C) tin (IV) salts of organic carboxylic acids having 1-32 carbon atoms, preferably 1-20 carbon atoms, e.g., diethyltin diacetate, dibutyltin diacetate, dibutyltin diacetate, dibutyltin dilaurate, dibutyltin maleate, dihexyltin diacetate, and dioctyltin diacetate.

Other suitable organotin catalysts are organotin alkoxides and mono or polyalkyl (1-8C) tin (IV) salts of inorganic compounds such as butyltin trichloride, dimethyl- and diethyl- and dibutyl- and dioctyl- and diphenyltin oxide, dibutyltin dibutoxide, di(2-ethylhexyl) tin oxide, dibutyltin dichloride, and dioctyltin dioxide. Preferred, however, are tin catalysts with tin-sulfur bonds which are resistant to hydrolysis, such as dialkyl (1-20C) tin dimercaptides, including dimethyl-, dibutyl-, and dioctyl-tin dimercaptides.

Tertiary amines also promote urethane linkage formation, and include triethylamine, 3-methoxypropyldimethylamine, triethylenediamine, tributylamine, dimethylbenzylamine, N-methyl-, N-ethyl- and N-cyclohexylmorpholine, N,N,N′,N′-tetramethylethylenediamine, N,N,N′,N′-tetramethylbutanediamine or -hexanediamine, N,N,N′-trimethyl isopropyl propylenediamine, pentamethyldiethylenetriamine, tetramethyldiaminoethyl ether, bis(dimethylaminopropyl)urea, dimethylpiperazine, 1-methyl-4-dimethylaminoethylpiperazine, 1,2-dimethylimidazole, 1-azabicylo[3.3.01octane and preferably 1,4-diazabicylo[2.2.21octane, and alkanolamine compounds, such as triethanolamine, triisopropanolamine, N-methyl- and N-ethyldiethanolamine and dimethylethanolamine.

To prepare the polyisocyanurate (PIR) and PUR-PIR products by the process according to the invention, a polyisocyanurate catalyst is used. Suitable polyisocyanurate catalysts are alkali salts, for example, sodium salts, preferably potassium salts and ammonium salts, of organic carboxylic acids, expediently having from 1 to 8 carbon atoms, preferably 1 or 2 carbon atoms, for example, the salts of formic acid, acetic acid, propionic acid, or octanoic acid, and tris(dialkylaminoethyl)-, tris(dimethylaminopropyl)-, tris(dimethylaminobutyl)- and the corresponding tris(diethylaminoalkyl)-s-hexahydrotriazines. However, (trimethyl-2-hydroxypropyl)ammonium formate, (trimethyl-2hydroxypropyl)ammonium octanoate, potassium acetate, potassium formate and tris(dimethylaminopropyl)-s-hexahydrotriazine are polyisocyanurate catalysts which are generally used. The suitable polyisocyanurate catalyst is usually used in an amount of from 1 to 10 parts by weight, preferably from 1.5 to 8 parts by weight, based on 100 parts by weight of the total amount of polyols.

Urethane-containing products may be prepared with or without the use of chain extenders and/or crosslinking agents (c), which are not necessary in this invention to achieve the desired mechanical hardness and dimensional stability. The chain extenders and/or crosslinking agents used have a number average molecular weight of less than 400, preferably from 60 to 300; or if the chain extenders have polyoxyalkylene groups, then having a number average molecular weight of less than 200.

Examples are dialkylene glycols and aliphatic, cycloaliphatic and/or araliphatic diols having from 2 to 14 carbon atoms, preferably from 4 to 10 carbon atoms, e.g., ethylene glycol, 1,3-propanediol, 1,10-decanediol, o-, m-, and p-dihydroxycyclohexane, diethylene glycol, dipropylene glycol, and preferably 1,4-butanediol, 1,6-hexanediol, bis(2-hydroxyethyl)hydroquinone, triols such as 1,2,4- and 1,3,5-trihydroxycyclohexane, glycerol, and trimethylolpropane.

Polyurethanes can also be prepared by using secondary aromatic diamines, primary aromatic diamines, 3,3′-di- and/or 3,3′-, 5,5′-tetraalkyl-substituted diaminodiphenylmethanes as chain extenders or crosslinking agents instead of or mixed with the above-mentioned diols and/or triols. The amount of chain extender, crosslinking agent or mixture thereof used, if any, is expediently from 2 to 20 percent by weight, preferably from 1 to 15 percent by weight, based on the weight of the polyol composition. However, it is preferred that no chain extender/crosslinker is used for the preparation of these products since the polyether polyols described above are sufficient to provide the desired mechanical properties.

If desired, assistants and/or additives can be incorporated into the reaction mixture for the production of the cellular plastics by the polyisocyanate polyaddition process. Specific examples are surfactants, stabilizers, cell regulators, fillers, dyes, pigments, flame-proofing agents, hydrolysisprotection agents, and fungistatic and bacteriostatic substances.

Examples of suitable surfactants are compounds which serve to support homogenization of the starting materials and may also regulate the cell structure of the plastics. Specific examples are salts of sulfonic acids, e.g., alkali metal salts or ammonium salts of dodecylbenzene- or dinaphthylmethanedisulfonic acid and ricinoleic acid; stabilizers, such as siloxane-oxyalkylene copolymers and other organopolysiloxanes, oxyethylated alkyl-phenols, oxyethylated fatty alcohols, paraffin oils, castor oil esters, ricinoleic acid esters, Turkey red oil and groundnut oil, and cell regulators, such as paraffins, fatty alcohols, and dimethylpolysiloxanes. The surfactants are usually used in amounts of 0.01 to 5 parts by weight, based on 100 parts by weight of the polyol component.

For the purposes of the invention, fillers are conventional organic and inorganic fillers and reinforcing agents. Specific examples are inorganic fillers, such as silicate minerals, for example, phyllosilicates such as antigorite, serpentine, hornblends, amphiboles, chrysotile, and talc; metal oxides, such as kaolin, aluminum oxides, titanium oxides and iron oxides; metal salts, such as chalk, barite and inorganic pigments, such as cadmium sulfide, zinc sulfide and glass, inter alia; kaolin (china clay), aluminum silicate and co-precipitates of barium sulfate and aluminum silicate, and natural and synthetic fibrous minerals, such as wollastonite, metal, and glass fibers of various lengths.

Examples of suitable organic fillers are carbon black, melamine, colophony, cyclopentadienyl resins, cellulose fibers, polyamide fibers, polyacrylonitrile fibers, polyurethane fibers, and polyester fibers based on aromatic and/or aliphatic dicarboxylic acid esters, and in particular, carbon fibers. The inorganic and organic fillers may be used individually or as mixtures and may be introduced into the polyol composition or isocyanate side in amounts of from 0.5 to 40 percent by weight, based on the weight of components (the polyol composition and the isocyanate); but the content of mats, nonwovens and wovens made from natural and synthetic fibers may reach values of up to 80 percent (W).

Examples of suitable flameproofing agents are tricresyl phosphate, tris(2-chloroethyl) phosphate, tris(2-chloropropyl) phosphate, and tris(2,3-dibromopropyl) phosphate. In addition to the above-mentioned halogen-substituted phosphates, it is also possible to use inorganic or organic flameproofing agents, such as red phosphorus, aluminum oxide hydrate, antimony trioxide, arsenic oxide, ammonium polyphosphate (Exolit®) and calcium sulfate, expandable graphite or cyanuric acid derivatives, e.g., melamine, or mixtures of two or more flameproofing agents, e.g., ammonium polyphosphates and melamine, and, if desired, corn starch, or ammonium polyphosphate, melamine, and expandable graphite and/or, if desired, aromatic polyesters, in order to flameproof the polyisocyanate polyaddition products. In general, from 2 to 50 parts by weight, preferably from 5 to 25 parts by weight, of said flameproofing agents may be used per 100 parts by weight of the polyol composition.

Further details on the other conventional assistants and additives mentioned above can be obtained from the specialist literature, for example, from the monograph by J. H. Saunders and K. C. Frisch, High Polymers, Volume XVI, Polyurethanes, Parts 1 and 2, Interscience Publishers 1962 and 1964, respectively, or Kunststoff-Handbuch, Polyurethane, Volume VII, Carl-Hanser-Verlag, Munich, Vienna, 1st and 2nd Editions, 1966 and 1983.

According to the present invention, the reaction time of the reaction mixture is adjusted in order to allow applying the reaction mixture to the area to be covered. Measures to adjust the reactivity of the reaction mixture are known to the person skilled in the art.

Methods to apply the reaction mixture, in particular by spraying are generally known. For applying a sprayed product, the machine preferably has separate controls to regulate the temperature of the component pre-heaters and the hose heater according to the present invention. The working temperature preferably is regulated between 30-100° C. depending on the external weather conditions. The components pressure preferably is adjusted between 60 and 200 bar in high pressure machines. The pressure and temperatures need to be regulated in function of the spray gun and mixing chamber to ensure a good mixing quality and spray pattern to properly apply the product.

Due to the short reaction times, the product can be sprayed on vertical walls as well ceilings without adhesion problems. The curing and hardening is very fast. After only few minutes the product can support mechanical loading; however, the complete curing time is considered to be approximately 24 hours depending on ambient temperatures and on the reactivity of the reaction mixture used.

It is important to make sure that the product is projected correctly as a liquid when it leaves the spray gun, turning to compact layer or foam in a few seconds. The distance between the gun and the surface can vary, but it preferably is around 40-80 cm. The product preferably will be sprayed in sections.

For foams, the thickness of the layer (L1) can vary in broad ranges. However, it is preferred to use thin layers in order to reduce the costs always making sure a correct covering is achieved. Suitable layers have a thickness in the range of 1 mm to 80 mm, such as in the range of from 3 mm to 60 mm, preferably 5 mm to 60 mm, more preferably from 10 mm to 50 mm, in particular 20 mm to 30 mm.

According to a further embodiment, the present invention is directed to the use of a composite as defined above, wherein the layer (L1) has a thickness in the range of 1 mm to 80 mm.

According to a further embodiment, the present invention is also directed to the use of a composite comprising a polyurethane foam layer (L1) as defined above, wherein the polyurethane foam layer (L1) has a thickness in the range of 3 mm to 60 mm.

A suitable density of the layer (L1) according to the present invention is in the range of from 30 to 2000 kg/m³. For foams the density preferably is in the range of from 50 to 1000 kg/m³, in particular 100 to 500 kg/m³. According to the present invention, materials are used which can be used in the form of comparatively thin layers and good results are obtained. In particular a foam layer might have a density in the range of from 30 to 800 kg/m³.

According to a further embodiment, the present invention is directed to the use of a composite as defined above, wherein the layer (L1) has a density in the range of from 30 to 2000 kg/m³.

According to a further embodiment, the present invention is also directed to the use of a composite comprising a polyurethane foam layer (L1) as defined above, wherein the polyurethane foam layer (L1) has a density in the range of from 30 to 800 kg/m³.

According to the present invention, it is also possible that the composite comprises additional layers such as reinforcing layers like a mesh or fibers or additional layers in order to improve the regeneration of the landfill area.

According to a further embodiment, the present invention is directed to the use of a composite as defined above, wherein the composite further comprises a mesh or fibers.

According to a further embodiment, the present invention is also directed to the use of a composite comprising a polyurethane foam layer (L1) as defined above, wherein the composite further comprises a mesh or fibers.

Furthermore, the composite may comprise additional layers such as layers to improve adhesion like latex or epoxy-resin layers, layers to improve the stability and to protect the product, like mortar or elastomer layers or layers which improve the regeneration of the landscape such as layers of soil or sand.

The present invention is also directed to a process for preparing a composite landfill liner comprising a layer (L1) selected from the group of polyurethane layers, polyisocyanurat layers and polyurea layers, the process comprising the step of applying a reaction mixture which is suitable to form a layer selected from the group of polyurethane, polyisocyanurat and polyurea onto a surface.

According to another aspect, the present invention is directed to a process for preparing a composite landfill liner comprising a layer (L1) selected from the group of polyurethane layers, polyisocyanurat layers and polyurea layers, the process comprising the step
(i) applying a reaction mixture which is suitable to form a product selected from the group of polyurethane, polyisocyanurat and polyurea products onto a surface.

Furthermore, the present invention is directed to a process for preparing a composite landfill liner comprising a polyurethane foam layer (L1), the process comprising the step
(i) applying a reaction mixture which is suitable to form a polyurethane foam onto a surface.

With respect to preferred embodiments, reference is made to the disclosure above with respect to the composites. As disclosed above, it is preferred to apply the layer (L1) by spraying the reaction mixture onto a surface. More preferably, a reaction mixture which is suitable to form a compact layer or a foam layer is used.

According to a further embodiment, the present invention therefore is directed to the process for preparing a composite landfill liner as defined above, wherein the layer (L1) is applied according to step (i) by spraying the reaction mixture onto a surface.

According to a further embodiment, the present invention is also directed to the process for preparing a composite landfill liner comprising a polyurethane foam layer (L1) as defined above, wherein the layer (L1) is applied according to step (i) by spraying the reaction mixture onto a surface.

According to a further embodiment, the present invention is directed to the process for preparing a composite landfill liner as defined above, wherein the layer (L1) selected from the group of polyurethane compact layers, polyisocyanurat compact layers, polyurea compact layers, polyurethane foam layers, polyisocyanurat foam layers and polyurea foam layers.

Preferably, the reaction mixture which is suitable to form a layer is applied by means of specific machinery which can correctly manipulate 2 or 3 liquid components which are mixed by a spraygun and are sprayed onto the surface. On the surface, the product reacts forming the polyurethane layer, polyisocyanurat layer or polyurea layer.

According to the present invention, the reaction mixture can be prepared in advance and applied as such. However, it is also possible to spray the individual components simultaneously in order to guarantee that a reaction between the components of the reaction mixture takes place.

Optionally, the process according to the present invention can also comprise an additional step of applying a primer on the surface of the layer (L1) to obtain a layer (L1′). Furthermore, preferably additional layers are applied onto the layer (L1). A protective layer might be applied according to the present invention selected from the group of mortar layers or elastomer layers. Suitable primers are for example selected from latex and epoxy resins. Furthermore, to improve the refurbishing, a layer L3 might be applied selected from the group of soil, sand and substrates suitable for plant growth.

According to a further embodiment, the present invention is directed to the process for preparing a composite landfill liner as defined above, wherein the process further comprises the step
(ii) applying a primer on the surface of the layer (L1) to obtain a layer (L1′),
(iii) applying a protective layer (L2) selected from the group of mortar layers or elastomer layers.

According to a further embodiment, the present invention is also directed to the process for preparing a composite landfill liner comprising a polyurethane foam layer (L1) as defined above, wherein the process further comprises the step
(ii) applying a primer on the surface of the layer (L1) to obtain a layer (L1′),
(iii) applying a protective layer (L2) selected from the group of mortar layers or elastomer layers.

Suitably, the primer layer might be applied in an amount of 50 to 500 g/m² and have a thickness in the range of from 0.05 to 0.5 cm. The mortar layer might have a thickness in the range of from 0.5 to 8 cm. A suitable elastomer layer might have a thickness in the range of from 0.3 to 5 cm.

According to a further embodiment, the present invention is directed to the process for preparing a composite landfill liner as defined above, wherein the process further comprises the step
(iv) applying a layer (L3) selected from the group of soil, sand or substrates suitable for plant growth.

According to a further embodiment, the present invention is also directed to the process for preparing a composite landfill liner comprising a polyurethane foam layer (L1) as defined above, wherein the process further comprises the step

(iv) applying a layer (L3) selected from the group of soil, sand or substrates suitable for plant growth.

The process according to the present invention therefore might consist of steps (i), (ii) and (iii), or of steps (i) and (iv), or of steps (i) and (iii); or of steps (i), (ii), and (iv), or of steps (i), (iii) and (iv) or of suitable other combinations such as (i), (ii), (iii), and (iv).

The present invention is also directed to a composite comprising a layer (L1). According to another aspect of the present invention, the use of a product selected from the group of polyurethane, polyisocyanurat and polyurea for a landfill liner is contemplated.

According to another aspect, the present invention is directed to a composite comprising a layer (L1) selected from the group of polyurethane layers, polyisocyanurat layers and polyurea layers, a primer layer on one surface of layer (L1), and a protective layer (L2) selected from the group of mortar layers or elastomer layers on the surface of the primer layer.

According to a further embodiment, the present invention is directed to the composite as defined above, wherein the layer (L1) is a selected from the group of polyurethane compact layers, polyisocyanurat compact layers, polyurea compact layers, polyurethane foam layers, polyisocyanurat foam layers and polyurea foam layers.

The present invention is in particular directed to a composite comprising a polyurethane foam layer (L1), a primer layer on one surface of layer (L1), and a protective layer (L2) selected from the group of mortar layers or elastomer layers on the surface of the primer layer.

The improved properties of the composites according to the present invention are also illustrated by the examples.

According to a further aspect, the present invention is directed to the use of a compound selected from the group of polyurethane, polyisocyanurat and polyurea for a landfill liner. According to another embodiment, the present invention is directed to the use of a compound selected from the group of polyurethane, polyisocyanurat and polyurea for a landfill liner, preferably in the form of a foam or a compact layer. In particular, the present invention is directed to the use of a polyurethane foam for a landfill liner.

The present invention includes the following embodiments, wherein these include the specific combinations of embodiments as indicated by the respective interdependencies defined therein.
1. Use of a composite comprising a layer (L1) selected from the group of polyurethane layers, polyisocyanurat layers and polyurea layers as a landfill liner.
2. The use according to embodiment 1, wherein the layer (L1) comprises a spray product.
3. The use according to embodiment 1 or 2, wherein the layer (L1) is selected from the group consisting of polyurethane compact layers, polyisocyanurat compact layers, polyurea compact layers, polyurethane foam layers, polyisocyanurat foam layers and polyurea foam layers.
4. The use according to any of embodiment 1 to 3, wherein the layer (L1) has a thickness in the range of 1 mm to 80 mm.
5. The use according to any of embodiments 1 to 4, wherein the layer (L1) has a density in the range of from 30 to 2000 kg/m³.
6. The use according to any of embodiments 1 to 5, wherein the composite further comprises a mesh or fibers.
7. A process for preparing a composite landfill liner comprising a layer (L1) selected from the group of polyurethane layers, polyisocyanurat layers and polyurea layers, the process comprising the step
   (i) applying a reaction mixture which is suitable to form a product selected from the group of polyurethane, polyisocyanurat and polyurea products onto a surface.
8. The process according to embodiment 7, wherein the layer (L1) is applied according to step (i) by spraying the reaction mixture onto a surface.
9. The process according to embodiment 7 or 8, wherein the layer (L1) selected from the group of polyurethane compact layers, polyisocyanurat compact layers, polyurea compact layers, polyurethane foam layers, polyisocyanurat foam layers and polyurea foam layers.
10. The process according to any of embodiments 7 to 8, wherein the process further comprises the step
   (ii) applying a primer on the surface of the layer (L1) to obtain a layer (L1′),
   (iii) applying a protective layer (L2) selected from the group of mortar layers or elastomer layers.
11. The process according to any of embodiments 7 to 10, wherein the process further comprises the step
   (iv) applying a layer (L3) selected from the group of soil, sand or substrates suitable for plant growth.
12. A composite comprising a layer (L1) selected from the group of polyurethane layers, polyisocyanurat layers and polyurea layers, a primer layer on one surface of layer (L1), and a protective layer (L2) selected from the group of mortar layers or elastomer layers on the surface of the primer layer.
13. A composite according to embodiment 12, wherein the layer (L1) is a selected from the group of polyurethane compact layers, polyisocyanurat compact layers, polyurea compact layers, polyurethane foam layers, polyisocyanurat foam layers and polyurea foam layers.
14. Use of a compound selected from the group of polyurethane, polyisocyanurat and polyurea for a landfill liner.
15. The use according to embodiment 14, wherein the compound is used in the form of a foam or a compact layer.
16. Use of a composite comprising a polyurethane foam layer (L1) as a landfill liner, wherein the layer (L1) comprises a spray product.
17. The use according to embodiment 16, wherein the spray product is a rigid or semirigid polyurethane spray foam.
18. The use according to embodiment 16 or 17, wherein the polyurethane foam layer (L1) has a thickness in the range of 3 mm to 60 mm.
19. The use according to any of embodiments 16 to 18 wherein the polyurethane foam layer (L1) has a density in the range of from 30 to 800 kg/m³.
20. The use according to any of embodiments 16 to 19, wherein the composite further comprises a mesh or fibers.
21. A process for preparing a composite landfill liner comprising a polyurethane foam layer (L1), the process comprising the step
   (i) applying a reaction mixture which is suitable to form a polyurethane foam onto a surface.
22. The process according to embodiment 21, wherein the layer (L1) is applied according to step (i) by spraying the reaction mixture onto a surface.
23. The process according to embodiment 21 or 22, wherein the process further comprises the step
   (ii) applying a primer on the surface of the layer (L1) to obtain a layer (L1′),
   (iii) applying a protective layer (L2) selected from the group of mortar layers or elastomer layers.
24. The process according to any of embodiments 21 to 23, wherein the process further comprises the step
   (iv) applying a layer (L3) selected from the group of soil, sand or substrates suitable for plant growth.
25. A composite comprising a polyurethane foam layer (L1), a primer layer on one surface of layer (L1), and a protective layer (L2) selected from the group of mortar layers or elastomer layers on the surface of the primer layer.

Examples will be used below to illustrate the invention.

### EXAMPLES

### 1. Materials:

6 blocks of salt waste of 50×30×20 cm, obtained from the Potash extraction site La Botjosa (Sallent). The surface is irregular and sharp but compact. The Salt blocks composition is mainly NaCl with clay spots.
Elastospray 1602/5 Polyol and Lupranat M20S ISO are used in 100:100 in volume (Weight ratio 100:110) as a system with 100 kg/m³ density. The formulation is summarized below in table 1.

TABLE 1
formulation example

| Elastospray 1602/5 composition | % |
|---|---|
| Lupranol 3402 | 28 |
| Lupranol 1200 | 20 |
| Lupraphen 3905/1 | 17 |
| Lupragen TCPP flame retardant | 22 |
| Triethanolamine | 2 |
| Glycerin | 5 |
| Polycat 9 catalyst | 4 |
| Silicone surfactant | 1 |
| Water | 1 |
| Orange Pigment | 0.1 |

TABLE 2
Properties of the Polyol and Isocyanate
Polyol properties

| | | |
|---|---|---|
| Density | 1120 | Kg/m³ |
| Hydroxyl value | 370 | mg/g |
| Viscosity | 500 | mPas |

Isocyanate properties

| Density | 1240 | Kg/m³ |
|---|---|---|
| NCO-content | 31.5% | |
| Viscosity | 210 | mPas |

Mortar PUR developed solution: Foam-BASF 97088 Primer-BASF 97087 mortar
Both materials are the result of a development with the most suitable selection of arids resins and water for the mortar (Portland cement based) and acrylic ester, charge materials (Latex) and water for the primer.

TABLE 3
Physical properties of 97087 mortar

| Property | Unit | value | Norm |
|---|---|---|---|
| general appearance | — | grey powder | — |
| density | kg/m³ | 1310 ± 50 | UNE-EN 1097-3 |
| dry components | % | 100 | UNE-EN 12192-1 |
| granulometry | | | |
| (% passes 1 mm sieve) | | | |
| consistency | mm | 195 ± 10 | EN 1015-3 |

TABLE 4
Physical properties of 97088 primer

| Property | Unit | Value |
|---|---|---|
| appearance/color | — | colorless liquid |
| density | g/cm³ | aprox. 1.0 ± 0.1 |
| pH | — | 7.5 ± 1 |
| dry residue | % | aprox. 40 |

### 2. Method:

The polyurethane foam is applied by means of a gun all around the block except from the base up to an average thickness of 1 cm all over the surface.
The distance between the gun and the surface can vary, but it should preferably be around 40-80 cm. For larger areas, the foam will be sprayed in sections. When insulating a section, the product should be sprayed in a continuous way from left to right, or top to bottom, slowly advancing as the wave of the expanding foam grows behind the allied section.
The spraying should be done in horizontal or vertical directions checking that there are no points with excessive product accumulation. Spraying should be as perpendicular as possible to the substrate. If the shape or height of the dump mountain makes it difficult to reach this distance or proceed in an adequate way, a crane and a long hose may be used to ensure quality foam spraying
The same technique is used for the mortar primer and the mortar layer, applying from 50-100 gr/m² for the primer by means of an airless gun and after 30 minutes up to 24 h applying the 5 to 10 kg/m² mortar layer (5 mm) using a mortar spraying machine as Putzmeister MP25 which dries within a week.

Result:
Covering: OK
The irregular shape almost disappears by the foam.
Adhesion: OK, PUR and Salt adhesion is excellent. Salt breaks before separating the foam from it.
Consistence: OK, the layer is completely compact.
Waterproofness: OK, the sample resists a 6 m water column.
Material Compatibility with mortar: OK
Mortar is completely joined to the foam

### 3. Physical Properties of the Product:

Foam samples were taken and looked the principal physical properties that were relevant for the application. Typical physical properties are summarized in table 1
   Salt resistance behavior was tested using the long term water absorption test with saturated salt water bath comparing it to the original water bath both in aging conditions of 70° C.
   Conclusion: The foam offers excellent behavior for all the critical properties needed for the landfilling application.

TABLE 5

| | |
|---|---|
| Elastospray 1602/5 | Norm |

| | | |
|---|---|---|
| Density [Kg/m³] | DIN EN 1602 | 100 |
| Long term water absorption [% vol] | DIN EN 12087 | <2 |
| Closed cell content [%] | ISO 4590 | >90 |
| Salt resistance | | Ok |
| Compression resistance [N/mm²] | DIN EN 826 | 1.41 |

1: A landfill liner, comprising a composite comprising a polyurethane foam layer (L1),
wherein:
the polyurethane foam layer (L1) comprises a spray product; and
the spray product is a rigid or semirigid polyurethane spray foam.

2: The landfill liner of claim 1, wherein the polyurethane foam layer (L1) has a thickness in the range of 3 mm to 60 mm.

3: The landfill liner of claim 1, wherein the polyurethane foam layer (L1) has a density in the range of from 30 to 800 kg/m³.

4: The landfill liner of claim 1, wherein the composite further comprises a mesh or fibers.

5: A process for preparing a composite landfill liner comprising a polyurethane foam layer (L1), the process comprising:
(i) applying a reaction mixture which is suitable to form a polyurethane foam onto a surface, such that the polyurethane foam layer (L1) is applied by spraying the reaction mixture onto a surface, and the polyurethane foam layer (L1) comprises a spray product which is a rigid or semirigid polyurethane spray foam;
(ii) applying a primer on the surface of the polyurethane foam layer (L1) to obtain a layer (L1′); and
(iii) applying at least one protective layer (L2) selected from the group consisting of a mortar layer, an elastomer layer, and a mixture thereof.

6: The process according to claim 5, further comprising:
(iv) applying at least one layer (L3) selected from the group consisting of a soil, a sand, a substrate suitable for plant growth, and mixtures thereof.

7: The landfill liner of claim 2, wherein the polyurethane foam layer (L1) has a density in the range of from 30 to 800 kg/m³.

8: The landfill liner of claim 2, wherein the composite further comprises a mesh or fibers.

9: The landfill liner of claim 3, wherein the composite further comprises a mesh or fibers.

10: The process according to claim 5, further comprising an additional step of applying a primer on the surface of the polyurethane foam layer (L1) to obtain a layer (L1′).
